(19) United States
(12) Patent Application Publication
(10) Pub. No.: US 2013/0016920 A1
(43) Pub. Date: Jan. 17, 2013

(54) IMAGE PROCESSING DEVICE, IMAGE PROCESSING METHOD, PROGRAM AND RECORDING MEDIUM

(71) Applicants: Yasuhiro Matsuda, Tokyo (JP); Takahiro Nagano, Kanagawa (JP); Masashi Uchida, Tokyo (JP)

(72) Inventors: Yasuhiro Matsuda, Tokyo (JP); Takahiro Nagano, Kanagawa (JP); Masashi Uchida, Tokyo (JP)

(21) Appl. No.: 13/543,075

(22) Filed: Jul. 6, 2012

(30) Foreign Application Priority Data
Jul. 14, 2011 (JP) 2011-155711

(51) Int. Cl. G06K 9/32

(52) U.S. Cl. 382/299

(57) ABSTRACT

Provided is an image processing device including a model-based processing portion that generates an estimated low resolution image from a high resolution image, using an observation model that performs motion compensation processing and down-sampling processing, a feature amount calculation portion that calculates a feature amount of at least one of a spatial feature amount and a temporal feature amount from one of an observed low resolution image, which is a low resolution image that is actually observed, and the high resolution image, and a prediction operation portion that predicts and generates an image with higher image quality based on the high resolution image, using a parameter which corresponds to the calculated feature amount and which is obtained from the observed low resolution image, from the estimated low resolution image and from learning that is performed in advance.

### BACKGROUND

The present technology relates to an image processing device, an image processing method, a program and a recording medium. Particularly, the present technology relates to an image processing device, an image processing method, a program and a recording medium that make it possible to generate an optimal up-converted image at a higher speed.

As one type of high quality image processing, a method is proposed in which a high resolution image is generated by super-resolution processing using the Gauss-Seidel method (refer to Japanese Patent Application Publication No. JP-A-2008-140012, for example). With this method, processing in which a feedback value obtained by a super-resolution processor is added to a high resolution image held in a buffer is repeated at predetermined times to generate a high resolution image.

As another type of high quality image processing, reconstruction-based super-resolution processing is known that estimates a high resolution image from a plurality of low resolution images. Since the reconstruction-based super-resolution processing performs the high quality image processing using an observation model (a degradation model), it is also referred to as model-based processing.

The model-based processing will be explained with reference to FIG. 1.

In the model-based processing, a predetermined observation model is constructed in advance. In the example shown in FIG. 1, a camera model (it is assumed that a camera is used) and a model to correct camera motion (position alignment) are constructed as an observation model. In this observation model, for example, blur (optical blur, motion blur, PSF), pixel number conversion (down-conversion, progressive/interlace conversion) and noise are modeled. Further, in the observation model, position alignment processing is modeled such that camera motion and subject motion are estimated with sub-pixel precision.

When a high resolution image is input to the observation model, the position alignment processing is performed. After that, an image that is degraded by the camera model is output as an estimated low resolution image. In the model-based processing, the high resolution image is corrected so that an error (a difference) between the estimated low resolution image that is output by the observation model and a low resolution image that is actually observed by the camera (hereinafter referred to as an observed low resolution image) is reduced, and the corrected high resolution image is input to the observation model. This processing is repeatedly performed. Then, when it is determined that the error between the estimated low resolution image and the observed low resolution image is sufficiently small, it is concluded that a high quality, high resolution image is obtained and the obtained image is output.

In FIG. 1, for example, the observed low resolution image and the estimated low resolution image are images of standard definition interface (SDI) signals, and the high resolution image is an image of a high definition progressive (HDP) signal.

With this type of model-based processing, when the observation model is accurately defined, it is possible to restore a high resolution image having no aliasing.

### SUMMARY

However, normally, it is difficult to construct an accurate observation model. When the observation model is not accurate, it is not possible to appropriately correct the high-resolution image. As a result, negative effects occur, such as excessive emphasis of edges and details, overshoot, noise emphasis and the like, leading to a significant degradation of image quality.

To address these negative effects, technology is devised that inhibits image quality degradation and noise emphasis using information about the image obtained in advance (this technology is also referred to as a reconstruction-based super-resolution MAP technique). However, with these techniques, performance largely depends on the information about the image obtained in advance. Therefore, it is difficult to appropriately perform control, for each pixel (each space) or each time period, such that improvement in anti-aliasing performance, improvement in resolution and sensitivity, overshoot suppression, and noise reduction are all satisfied.

The present technology has been devised in light of the foregoing circumstances and makes it possible to generate an optimal up-converted image at a higher speed.

An image processing device according to an embodiment of the present technology includes: a model-based processing portion that generates an estimated low resolution image from a high resolution image, using an observation model that performs motion compensation processing and down-sampling processing; a feature amount calculation portion that calculates a feature amount of at least one of a spatial feature amount and a temporal feature amount from one of an observed low resolution image, which is a low resolution image that is actually observed, and the high resolution image; and a prediction operation portion that predicts and generates an image with higher image quality based on the high resolution image, using a parameter which corresponds to the calculated feature amount and which is obtained from the observed low resolution image, from the estimated low resolution image and from learning that is performed in advance.

An image processing method according to an embodiment of the present technology includes: generating an estimated low resolution image from a high resolution image, using an observation model that performs motion compensation processing and down-sampling processing; calculating a feature amount of at least one of a spatial feature amount and a temporal feature amount from one of an observed low resolution image, which is a low resolution image that is actually observed, and the high resolution image; and predicting and generating an image with higher image quality based on the high resolution image, using a parameter which corresponds to the calculated feature amount and which is obtained from the observed low resolution image, from the estimated low resolution image and from learning that is performed in advance.

A program according to an embodiment of the present technology includes instructions that command a computer to perform: generating an estimated low resolution image from a high resolution image, using an observation model that performs motion compensation processing and down-sampling processing; calculating a feature amount of at least one of a spatial feature amount and a temporal feature amount from one of an observed low resolution image, which is a low resolution image that is actually observed, and the high resolution image; and predicting and generating an image with higher image quality based on the high resolution image, using a parameter which corresponds to the calculated feature amount and which is obtained from the observed low resolution image, from the estimated low resolution image and from learning that is performed in advance.

According to the embodiments of the present technology, an estimated low resolution image is generated from a high resolution image, using an observation model that performs motion compensation processing and down-sampling processing. A feature amount of at least one of a spatial feature amount and a temporal feature amount is calculated from one of an observed low resolution image, which is a low resolution image that is actually observed, and the high resolution image. An image with higher image quality is predicted and generated based on the high resolution image, using a parameter which corresponds to the calculated feature amount and which is obtained from the observed low resolution image, from the estimated low resolution image and from learning that is performed in advance.

Note that the program can be provided by transmitting it via a transmission medium or can be provided by recording it on a recording medium.

The image processing device may be an independent device, or may be an internal block included in a device.

According to the embodiments of the present technology, it is possible to generate an optimal up-converted image at a higher speed.

### BRIEF DESCRIPTION OF THE DRAWINGS

FIG. 1 is a diagram illustrating known model-based processing;

FIG. 2 is a block diagram showing a configuration example of the known model-based processing;

FIG. 3 is a conceptual diagram of the known model-based processing;

FIG. 4 is a conceptual diagram of a prediction device as an image processing device to which the present technology is applied;

FIG. 5 is a conceptual diagram of a learning device to which the present technology is applied;

FIG. 6 is a diagram illustrating a schematic configuration of the learning device to which the present technology is applied;

FIG. 7 is a diagram illustrating a schematic configuration of the prediction device to which the present technology is applied;

FIG. 8 is a block diagram showing a detailed configuration example of the learning device to which the present technology is applied;

FIG. 9 is a diagram illustrating a spatial feature amount calculation portion and a temporal feature amount calculation portion;

FIG. 10 is a diagram illustrating the spatial feature amount calculation portion;

FIG. 11 is a block diagram showing a detailed configuration example of a coefficient learning portion;

FIG. 12 is a flowchart illustrating prediction coefficient learning processing performed by the learning device;

FIG. 13 is a flowchart illustrating, in detail, model-based processing;

FIG. 14 is a flowchart illustrating, in detail, sample accumulation processing;

FIG. 15 is a flowchart illustrating, in detail, spatial feature amount class classification processing;

FIG. 16 is a flowchart illustrating, in detail, temporal feature amount class classification processing;

FIG. 17 is a block diagram showing a detailed configuration example of the prediction device to which the present technology is applied;

FIG. 18 is a block diagram showing a detailed configuration example of a prediction portion;

FIG. 19 is a flowchart illustrating high resolution image generation processing performed by the prediction device;

FIG. 20 is a flowchart illustrating, in detail, prediction processing; and

FIG. 21 is a block diagram showing a configuration example of one embodiment of a computer to which the present technology is applied.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Configuration Example of Known Model-Based Processing Portion

First, a configuration of a model-based processing portion that performs the model-based processing explained in the background section will be explained.

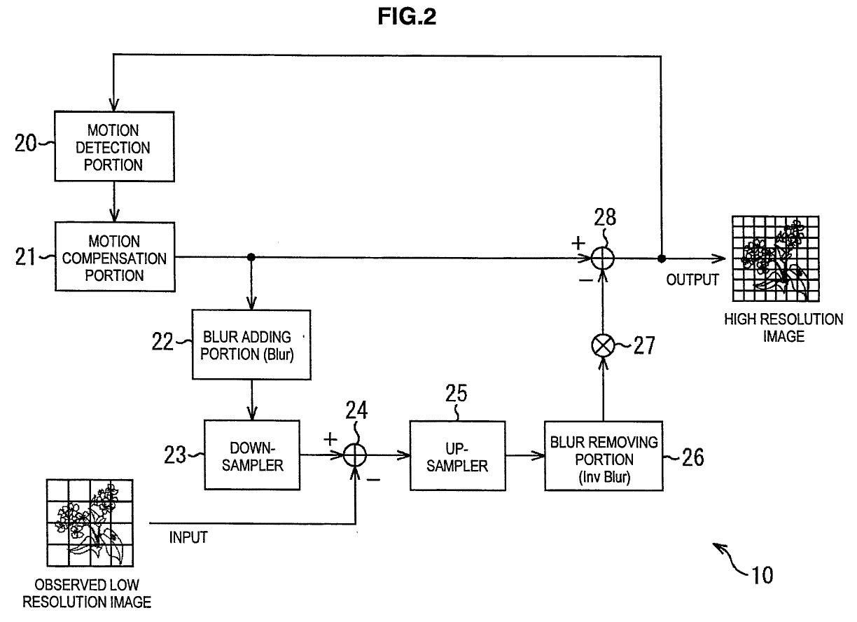

FIG. 2 is a block diagram showing a configuration example of a model-based processing portion 10 that performs the model-based processing.

The model-based processing portion 10 is provided with a motion detection portion 20, a motion compensation portion 21, a blur adding portion 22, a down-sampler 23, an adder 24, an up-sampler 25, a blur removing portion 26, a multiplier 27 and an adder 28.

The motion detection portion 20 detects a motion amount (a motion vector) of each pixel by comparing a high resolution image supplied (fed back) from the adder 28 with a high resolution image of one unit time in advance (one frame before, for example).

The motion compensation portion 21 performs motion compensation based on the motion amount detected by the motion detection portion 20. Note that an image output from the motion compensation portion 21 is referred to as a motion-compensated high resolution image of one frame before, as appropriate. The motion-compensated high resolution image of one frame before is supplied to the blur adding portion 22 and the adder 28.

The blur adding portion 22 adds blur, such as that occurs when an image is captured by a camera, to the motion-compensated high resolution image of one frame before. Here, processing performed by the blur adding portion 22 generating an image in which a point spread function (PSF), optical blur and the like of the camera are estimated (simulated) based on a predetermined image is referred to as blur adding processing. The motion-compensated high resolution image of one frame before, to which blur is added, is then supplied to the down-sampler 23.

The down-sampler 23 generates a low resolution image by, for example, thinning out pixels of the motion-compensated high resolution image of one frame before to which blur has been added. Thus, an estimated low resolution image is generated.

The adder 24 calculates a difference value (an error) between each pixel of the estimated low resolution image and each pixel of an observed low resolution image. Difference information, which is a calculation result of the adder 24, is supplied to the up-sampler 25.

The up-sampler 25 performs up-sampling on the low resolution difference information, which is the calculation result of the adder 24, to obtain difference information of the high resolution image. More specifically, the up-sampler 25 generates a difference value corresponding to each high resolution pixel from the difference value corresponding to each low resolution pixel, and supplies the generated difference value to the blur removing portion 26.

The blur removing portion 26 performs blur removing processing on the high resolution difference information supplied from the up-sampler 25. The blur removing processing is inverse processing of the processing performed by the blur adding portion 22. In other words, the blur removing portion 26 performs, on the high resolution difference information, the processing to remove the blur added by the blur adding portion 22.

Note that, when blur is not taken into account in an observation model, the blur adding portion 22 and the blur removing portion 26 can be omitted.

The multiplier 27 multiplies the high resolution difference information output from the blur removing portion 26 by a predetermined gain, and outputs a multiplication result to the adder 28.

The adder 28 adds a pixel value (a luminance value) of each of the pixels of the motion-compensated high resolution image of one frame before and the difference information (the difference value) from the multiplier 27, and outputs an addition result as a high resolution image. Further, the adder 28 also supplies the generated high resolution image to the motion detection portion 20 (namely, performs feedback).

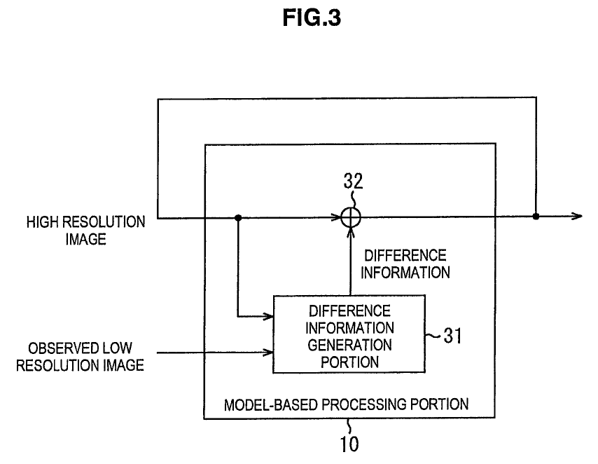

A processing block diagram of the above-described model-based processing portion 10 can be conceptually expressed as shown in FIG. 3.

More specifically, the model-based processing portion 10 is provided with a difference information generation portion 31 and an adding portion 32. The difference information generation portion 31 generates difference information to update the high resolution image, from the high resolution image of one frame before and from the observed low resolution image. Then, the generated difference information is added to the high resolution image of one frame before by the adding portion 32, thereby generating an updated high resolution image. This processing is repeatedly performed.

In the known model-based processing portion 10 configured in this manner, the difference information to be generated is obtained as a uniform value for each of the pixels of the high resolution image to be generated. Accordingly, in order to output one sheet of the high resolution image without image quality degradation, it is necessary to perform a repeated operation certain number of times so that the difference information that sufficiently reduces the error between the estimated low resolution image and the observed low resolution image can be obtained for all the pixels in the high resolution image.

Conceptual Diagram of Prediction Device and Learning Device of the Present Technology

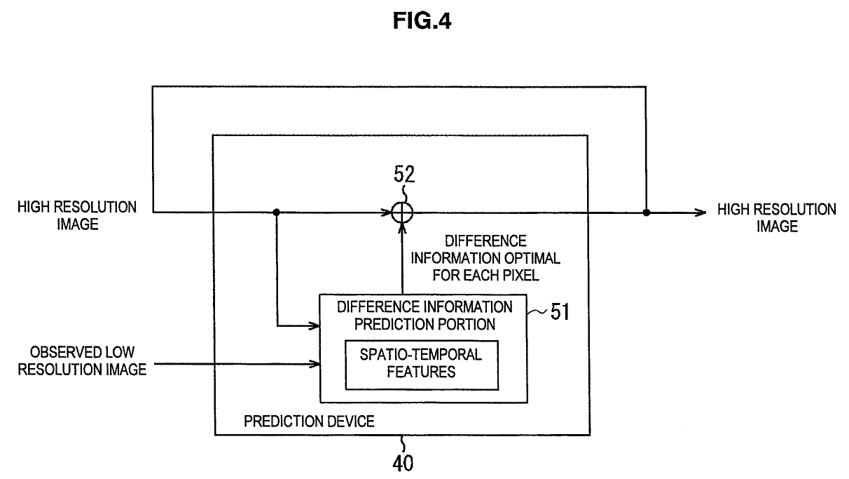

FIG. 4 shows a prediction device 40 as an image processing device to which the present technology is applied. The prediction device 40 is shown such that it corresponds to the block diagram shown in FIG. 3 that conceptually shows the known model-based processing portion 10.

The prediction device 40 to which the present technology is applied is provided with a difference information prediction portion 51 and an adding portion 52.

The difference information generation portion 51 generates difference information that is optimal for each pixel of the high resolution image to be updated, using a prediction coefficient corresponding to spatio-temporal features of the high resolution image of one frame before and of the observed low resolution image. Then, the generated difference information that is optimal for each pixel is added to the high resolution image of one frame before by the adding portion 52, and thus an updated high resolution image is generated.

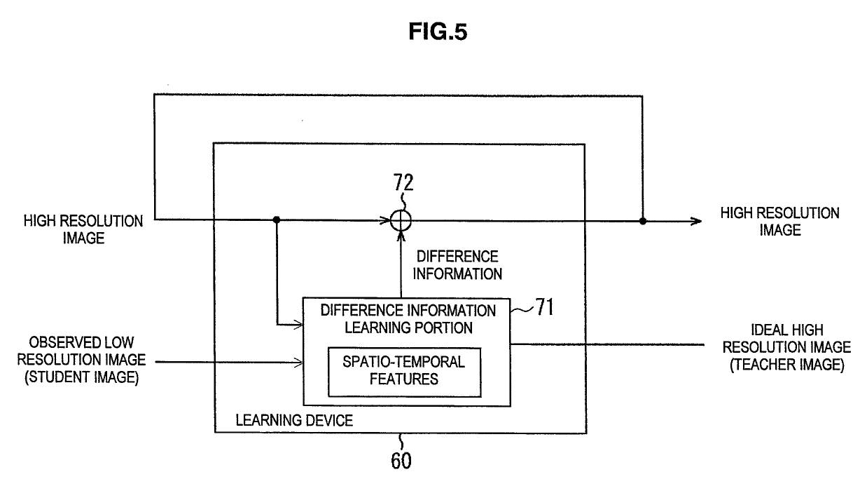

The prediction coefficient used by the difference information generation portion 51 is learned in advance by a learning device 60 shown in FIG. 5, which will be described later. With the prediction device 40 shown in FIG. 4, a repeated operation is not necessary in order to output one sheet of a high resolution image, and it is possible to obtain a high resolution image by performing addition once for each pixel. Note that the feedback of the high resolution image shown in FIG. 4 is to generate a high resolution image of one frame after.

FIG. 5 is a block diagram conceptually showing the learning device 60 that learns the prediction coefficient used by the prediction device 40 shown in FIG. 4.

The learning device 60 shown in FIG. 5 is provided with a difference information learning portion 71 and an adding portion 72.

The difference information learning portion 71 learns the prediction coefficient that minimizes an error between the high resolution image to be generated and an ideal high resolution image, using paired data of the ideal high resolution image as a teacher image and an observed low resolution image as a student image, and the high resolution image to be generated. To learn the prediction coefficient, spatio-temporal features of the high resolution image and the observed low resolution image are used in the same manner as in prediction processing.

Note that, in actuality, the learning device 60 does not learn the prediction coefficient that optimizes the difference information, but optimizes the high resolution image itself of a target frame based on the high resolution image of one frame before and the observed low resolution image, as explained below. That is, the learning device 60 learns a prediction coefficient used to predict a high quality, high resolution image. Then, the prediction device 40 does not generate the difference information using the prediction coefficient learned by the learning device 60, but directly generates the high resolution image to be output.

Schematic Configuration of Learning Device

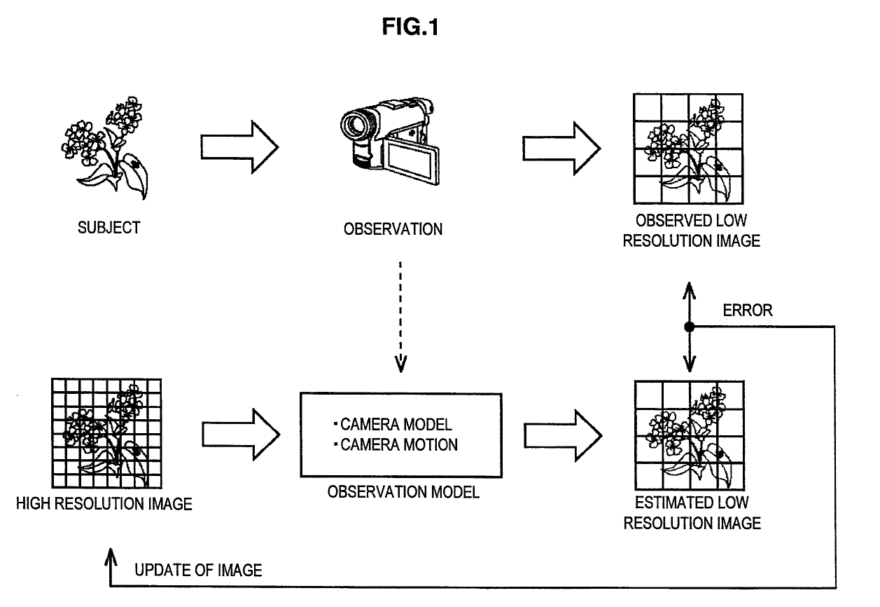

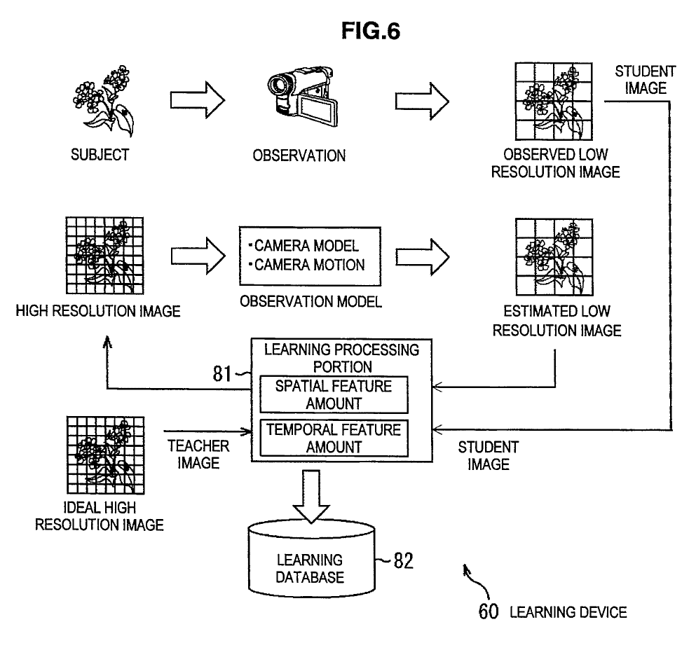

FIG. 6 shows a schematic configuration of the learning device 60, which is illustrated to correspond to the known model-based processing shown in FIG. 1.

First, an ideal high resolution image, which is a teacher image, and an observed low resolution image, which is a student image, are prepared. Then, an estimated low resolution image that is generated from the high resolution image of one frame before using the observation model of the model-based processing portion is input to a learning processing portion 81, together with the teacher image and the student image.

The learning processing portion 81 calculates (learns) a prediction coefficient which is included in a prediction operational expression used to generate a high resolution image and which minimizes the error between the ideal high resolution image that is the teacher image and the high resolution image to be generated. In the learning, the prediction coefficient can be obtained for each of a plurality of classified classes. The learning processing portion 81 calculates the prediction coefficient for each of the classes that are classified based on the spatial feature amount of the student image and the temporal feature amount of the high resolution image of one frame before. Then, the prediction coefficient calculated by the learning processing portion 81 for each of the classes is stored in a learning database 82.

Schematic Configuration of Prediction Device

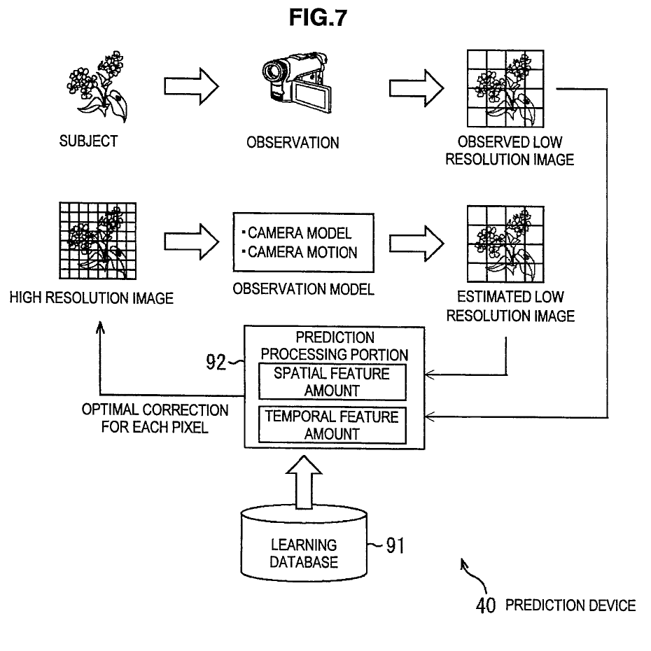

FIG. 7 shows a schematic configuration of the prediction device 40, which is illustrated to correspond to the known model-based processing shown in FIG. 1.

The prediction coefficient for each of the classes learned by the learning device 60 shown in FIG. 6 is stored in a learning database 91 of the prediction device 40. In other words, the learning database 91 shown in FIG. 7 is the same as the learning database 82 shown in FIG. 6, or the data in the learning database 82 is transferred to the learning database 91.

A prediction processing portion 92 generates a high resolution image by calculating the prediction operational expression that uses the prediction coefficients obtained by the learning of the learning device 60. More specifically, the prediction processing portion 92 performs class classification based on the spatial feature amount of the observed low resolution image and the temporal feature amount of the high resolution image of one frame before. Then, the prediction processing portion 92 acquires, from the learning database 91, the prediction coefficients corresponding to the classes that are classification results when performing the class classification, and uses the prediction coefficients in the prediction operation.

Hereinafter, further detailed configurations of the learning device 60 and the prediction device 40 will be explained in order.

Detailed Configuration Block Diagram of Learning Device 60

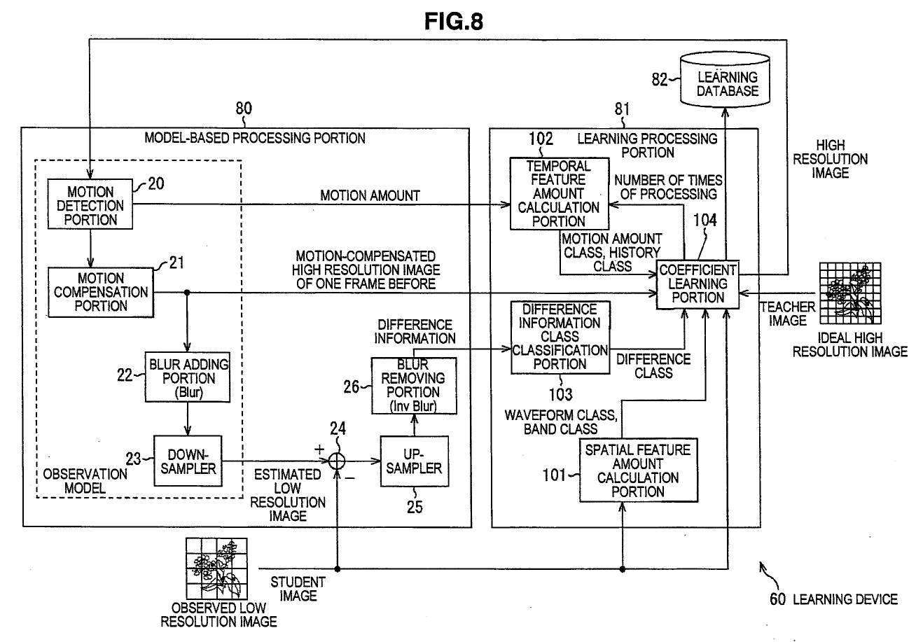

FIG. 8 is a block diagram showing a detailed configuration example of the learning device 60. In FIG. 8, portions corresponding to the above-described portions are denoted by the same reference numerals and an explanation thereof is omitted as appropriate.

The learning device 60 is provided with a model-based processing portion 80, the learning processing portion 81 and the learning database 82.

The model-based processing portion 80 basically has the same configuration as that of the model-based processing portion 100 explained with reference to FIG. 2, and generates the estimated low resolution image from the high resolution image using an observation model that performs motion compensation processing and down-sampling processing. Note that, the learning device 60 to which the present technology is applied is not provided with the adder 27 and the adder 28 because it does not uniformly provide the difference information to the high resolution image of one frame before, unlike the known model-based processing.

The learning processing portion 81 is provided with a spatial feature amount calculation portion 101, a temporal feature amount calculation portion 102, a difference information class classification portion 103 and a coefficient learning portion 104.

The spatial feature amount calculation portion 101 and the temporal feature amount calculation portion 102 function as a class classification portion that calculates the spatial feature amount or the temporal feature amount of a target pixel that is set for the high resolution image to be generated, and classifies the target pixel into predetermined classes based on the calculated feature amount. Further, the difference information class classification portion 103 also functions as the class classification portion and classifies the target pixel into a predetermined class based on the difference information supplied from the blur removing portion 26.

The spatial feature amount calculation portion 101 is supplied with the observed low resolution image as the student image. The temporal feature amount calculation portion 102 is supplied with the motion amount that is detected by the motion detection portion 20 of the model-based processing portion 80, as well as a number of processing times (a number of processed sheets) of the target pixel from the coefficient learning portion 104.

Explanation of spatial feature amount calculation portion 101 and of temporal feature amount calculation portion 102

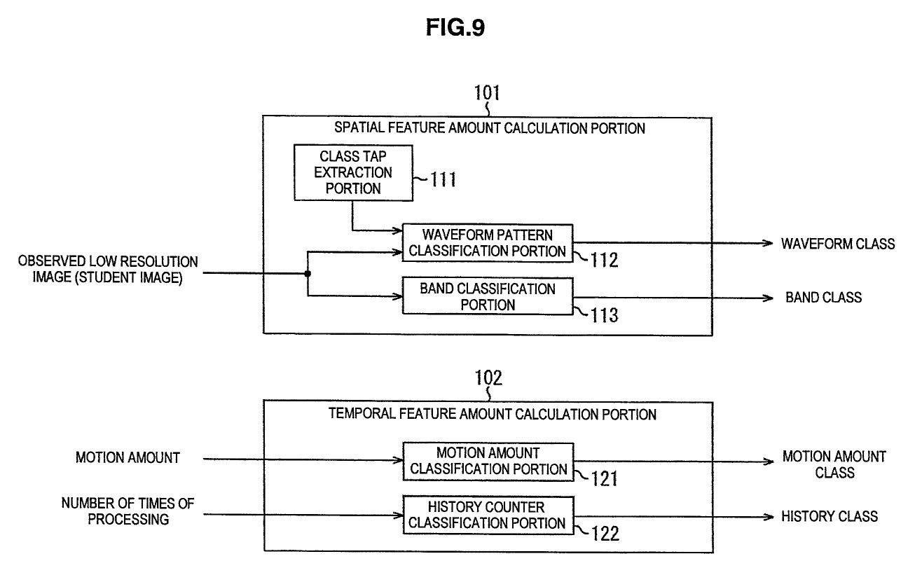

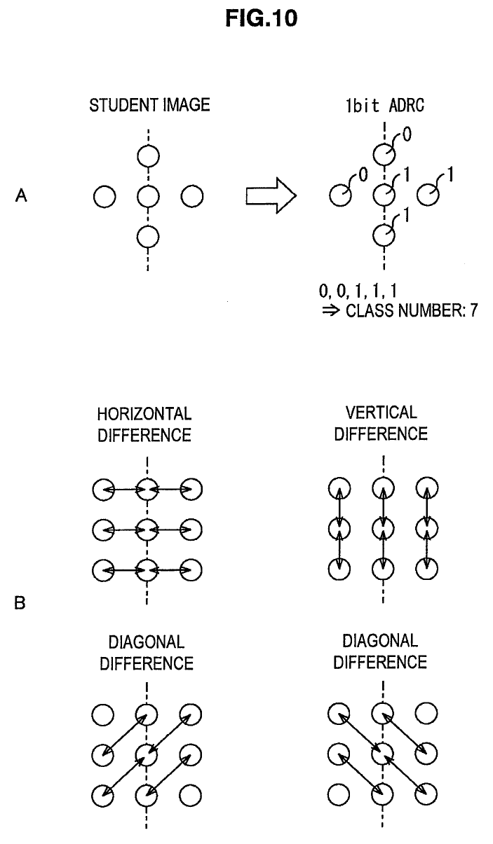

The spatial feature amount calculation portion 101 and the temporal feature amount calculation portion 102 will be explained with reference to FIG. 9 and FIG. 10.

FIG. 9 is a block diagram showing a detailed configuration example of the spatial feature amount calculation portion 101 and the temporal feature amount calculation portion 102.

The spatial feature amount calculation portion 101 is provided with a class tap extraction portion 111, a waveform pattern classification portion 112 and a band classification portion 113.

The class tap extraction portion 111 sets a plurality of pixels (surrounding pixels) located around the pixel of the student image (the observed low resolution image) that corresponds to the target pixel, as a class tap to set a class that is based on the spatial feature amount, and extracts the set class tap. Information indicating the extracted class tap is supplied to the waveform pattern classification portion 112.

The waveform pattern classification portion 112 classifies the target pixel into a predetermined waveform class based on a waveform pattern of the surrounding pixels set as the class tap, and outputs (a class code indicating) the waveform class to the coefficient learning portion 104 (refer to FIG. 8) as a classification result.

The band classification portion 113 classifies the target pixel into a predetermined band class based on a frequency band of the surrounding pixels of the target pixel, and outputs (a class code indicating) the band class to the coefficient learning portion 104 as a classification result.

The temporal feature amount calculation portion 102 is provided with a motion amount classification portion 121 and a history counter classification portion 122.

The motion amount classification portion 121 classifies the target pixel into a predetermined motion amount class based on the motion amount supplied from the motion detection portion 20, and outputs (a class code indicating) the motion amount class to the coefficient learning portion 104 (refer to FIG. 8) as a classification result.

More specifically, the motion amount classification portion 121 performs class classification of the target pixel for phases equal to or less than the phase of the pixel corresponding to the motion amount supplied from the motion detection portion 20. For example, when detection accuracy (detection resolution) of the motion amount is a ¼ phase (a ¼ pixel), a fractional part of the motion amount supplied from the motion detection portion 20 is one of the four values “00”, “25”, “50” and “75”. Therefore, the motion amount classification portion 121 performs class classification of the target pixel using the four values. More particularly, when the motion amount supplied from the motion detection portion 20 is “0.00, 1.00, 2.00, or the like, the class “0” is set, and when the motion amount is 0.25, 1.25, 2.25, or the like, the class “1” is set. When the motion amount is 0.50, 1.50, 2.50, or the like, the class “2” is set, and when the motion amount is 0.75, 1.75, 2.75, or the like, the class “3” is set. When the detection accuracy (the detection resolution) of the motion amount is a 1/N phase (a 1/N pixel), the motion amount class is classified into N classes.

The number of processing times (the number of processed sheets) that the position of the pixel set as the target pixel has been processed so far is supplied from the coefficient learning portion 104 to the history counter classification portion 122.

The history counter classification portion 122 outputs (the value of) the supplied number of processing times to the coefficient learning portion 104, as (a class code indicating) a history class that is a result of classifying the target pixel into a predetermined history class. For example, at an initial time when the processing has not yet been performed, the class “0” is set, and when two frames have been processed so far for the target pixel, the class “2” is set and when three frames have been processed, the class “3” is set.

FIG. 10 is a diagram illustrating an example of class classification processing performed by the waveform pattern classification portion 112 and the band classification portion 113.

FIG. 10A shows an example in which the waveform pattern classification portion 112 performs one-bit ADRC processing as waveform class classification processing that classifies the target pixel into the predetermined waveform class based on the waveform pattern.

In K-bit ADRC processing (K≧1), a maximum value MAX and a minimum value MIN of pixel values of the pixels that form the surrounding pixels are detected. DR=MAX−MIN is set as a local dynamic range of a group, and based on the dynamic range DR, the pixel values of the pixels that form the surrounding pixels are re-quantized to K bits. More specifically, the minimum value MIN is subtracted from the pixel value of each of the pixels that form the surrounding pixels, and the subtracted value is divided by DR/2^{K} (is quantized). Then, a bit stream in which the pixel values of the K-bit pixels that form the surrounding pixels are arranged in a predetermined order is output as an ADRC code.

When the one-bit ADRC processing is performed, the pixel value of each of the pixels that form the surrounding pixels is divided by an average value of the maximum value MAX and the minimum value MIN (the fractional part is removed). If the pixel value of each of the pixels is equal to or more than the average value, “1” is set, and if it is less than the average value, “0” is set (namely, binarization is performed). Then, a bit stream in which one-bit pixel values are arranged in the predetermined order is output as the ADRC code.

In the example shown in FIG. 10A, if five pixels that are set as the class tap are determined to be “0”, “0”, “1”, “1”, “1” in the predetermined order, “00111”=“7” is output as the class code of the waveform class.

FIG. 10B shows an example in which the band classification portion 113 uses nine pixels surrounding the target pixel to classify the target pixel into the predetermined band class.

With respect to the nine pixels surrounding the target pixel, the band classification portion 113 calculates a difference absolute value in the horizontal direction (a horizontal difference), a difference absolute value in the vertical direction (a vertical difference), and difference absolute values in the upper right direction and the lower right direction (diagonal differences). Then, the band classification portion 113 selects a maximum value among the calculated difference absolute values, and outputs the maximum value to the coefficient learning portion 104 as the class code indicating the band class. Note that, the pixels surrounding the target pixel that are selected to classify the target pixel into the predetermined band class are not limited to the nine pixels shown in FIG. 10B and can be set as appropriate.

Returning to FIG. 8, the coefficient learning portion 104 is supplied with the class codes that are the results of classifying the target pixel into each of the classes, namely, the waveform class, the band class, the motion amount class and the history class in the manner described above.

Further, from the difference information class classification portion 103, the coefficient learning portion 104 is also supplied with (a class code indicating) a difference class that is a result of classifying the target pixel into a predetermined difference class based on the difference information (the difference value) supplied from the blur removing portion 26.

Further, the coefficient learning portion 104 is supplied with the motion-compensated high resolution image of one frame before from the motion compensation portion 21 of the model-based processing portion 80. Further, the coefficient learning portion 104 is also supplied with the observed low resolution image as the student image and the ideal high resolution image as the teacher image.

The coefficient learning portion 104 sets each of the pixels of the ideal high resolution image, which is the teacher image, as a target pixel (a pixel of interest) and extracts, as a prediction tap, a plurality of pixels of the student image corresponding to the target pixel. Then, by performing a predetermined prediction operation that uses the extracted prediction tap and the prediction coefficients, the coefficient learning portion 104 calculates (learns) a prediction coefficient used to obtain a high quality, high resolution image.

If, for example, a linear prediction operation is used as the predetermined prediction operation, a pixel value y^{t} of the high quality, high resolution image at a time t (a t-th frame) is calculated based on the following linear expression.

$${y}^{t} = {\sum }_{i}^{N} {w}_{i} {x}_{i}^{t} + {{\sum }_{j}}^{M} {w}_{j} {x}_{j}^{t - 1} \qquad ( 1 )$$

Note that, in Expression (1), xᵢ indicates a pixel value of an i-th pixel (hereinafter referred to as a student image pixel, as appropriate) of the student image included in a prediction tap for the target pixel y^{t} of the high resolution image, and wᵢ indicates an i-th prediction coefficient that is multiplied by (the pixel value of) the i-th student image pixel. Further, xⱼ indicates a pixel value of a j-th pixel (hereinafter referred to as a previous high resolution image pixel, as appropriate) of the motion-compensated high resolution image of one frame before (a (t−1)-th frame) included in the prediction tap for the target pixel y^{t} of the high resolution image, and wⱼ indicates a j-th prediction coefficient that is multiplied by (the pixel value of) the j-th previous high resolution image pixel. Note that, in Expression (1), it is assumed that the prediction tap is formed by a number N of student image pixels x₁, x₂, . . . , x_{N} with respect to the student image pixels, and the prediction tap is formed by a number M of student image pixels x₁, x₂, . . . , x_{M} with respect to the previous high resolution image pixels. If the number M and the number N are increased, the number of prediction coefficients is increased. However, performance improvements are expected, such as rapid convergence of a super-resolution effect, reduction of isolated point-like excessive emphasis and degradation, and the like.

Instead of the linear expression shown by Expression (1), the pixel value y^{t} of the high resolution image can also be calculated using a quadratic or higher expression.

Expression (1) indicates a (M+N) number of linear expressions. However, in order to simplify the explanation, (M+N) is substituted by N (M+N→N) and is simplified as shown in Expression (2). At the same time, a true value of the pixel value of a teacher image pixel of a k-th sample is denoted by yₖ and a prediction value of the true value yₖ obtained by Expression (2) is denoted by a prediction value yₖ′. In this case, a prediction error eₖ is expressed by the following Expression (3).

$$\begin{matrix}y = {\sum }_{n = 1}^{N} {w}_{n} {x}_{n} & ( 2 ) \\ {e}_{k} = {y}_{k} - {y}_{k}^{′} & ( 3 )\end{matrix}$$

Since the prediction value yₖ′ in Expression (3) can be calculated according to Expression (2), if the prediction value yₖ′ in Expression (3) is substituted according to Expression (2), the following Expression (4) can be obtained.

$${e}_{k} = {y}_{k} - ( {\sum }_{n = 1}^{N} {w}_{n} {x}_{n , k} ) \qquad ( 4 )$$

Note that, in Expression (4), x_{n,k} indicates an n-th student image pixel included in the prediction tap with respect to the teacher image pixel of the k-th sample.

A prediction coefficient wₙ that causes the prediction error eₖ of Expression (4) (or Expression (3)) to be 0 is an optimal prediction coefficient to predict the teacher image pixel. However, generally, it is difficult to obtain this kind of prediction coefficient wₙ for all the teacher image pixels.

To address this, if the method of least squares, for example, is used as a standard to indicate that the prediction coefficient wₙ is optimal, the optimal prediction coefficient wₙ can be calculated by minimizing a total sum E of squared errors represented by the following Expression (5).

$$E = {\sum }_{k = 1}^{K} {e}_{k}^{2} \qquad ( 5 )$$

Note that, in Expression (5), K represents a sample number (a number of learning samples) of a set of the teacher image pixel yₖ and student image pixels x_{1,k}, x_{2,k}, . . . , x_{N,k} that form the prediction tap with respect to the teacher image pixel yₖ.

The minimum value (the smallest value) of the total sum E of the squared errors in Expression (5) is given by the prediction coefficient wₙ that causes the value obtained by differentiating the total sum E partially with respect to the prediction coefficient wₙ to be zero, as shown by Expression (6).

$$\frac{\partial E}{\partial {w}_{n}} = {e}_{1} \frac{\partial {e}_{1}}{\partial {w}_{n}} + {e}_{2} \frac{\partial {e}_{2}}{\partial {w}_{n}} + … + {e}_{k} \frac{\partial {e}_{k}}{\partial {w}_{n}} = 0 \\ ( n = 1 , 2 , … , N ) \qquad ( 6 )$$

Given this, if the above-described Expression (4) is partially differentiated with respect to the prediction coefficient wₙ, the following Expression (7) is obtained.

$$\frac{\partial {e}_{k}}{\partial {w}_{1}} = - {x}_{1} , k , \frac{\partial {e}_{k}}{\partial {w}_{2}} = - {x}_{2 , k} , … , \frac{\partial {e}_{k}}{\partial {w}_{N}} = - {x}_{N , k} , ( k = 1 , 2 , … , K ) \qquad ( 7 )$$

From Expression (6) and Expression (7), the following Expression (8) is obtained.

$${\sum }_{k = 1}^{K} {e}_{k} {x}_{1 , k} = 0 , {\sum }_{k = 1}^{K} {e}_{k} {x}_{2 , k} = 0 , … {\sum }_{k = 1}^{K} {e}_{k} {x}_{N , k} = 0 \qquad ( 8 )$$

By substituting Expression (4) for the prediction error eₖ in Expression (8), Expression (8) can be expressed by a normal equation, as represented by Expression (9).

$$[ \begin{matrix}( {\sum }_{k = 1}^{K} {x}_{1 , k} {x}_{1 , k} ) & ( {\sum }_{k = 1}^{K} {x}_{1 , k} {x}_{2 , k} ) & … & ( {\sum }_{k = 1}^{K} {x}_{1 , k} {x}_{N , k} ) \\ ( {\sum }_{k = 1}^{K} {x}_{2 , k} {x}_{1 , k} ) & ( {\sum }_{k = 1}^{K} {x}_{2 , k} {x}_{2 , k} ) & … & ( {\sum }_{k = 1}^{K} {x}_{2 , k} {x}_{N , k} ) \\ ⋮ & ⋮ & ⋱ & ⋮ \\ ( {\sum }_{k = 1}^{K} {x}_{N , k} {x}_{1 , k} ) & ( {\sum }_{k = 1}^{K} {x}_{N , k} {x}_{2 , k} ) & … & ( {\sum }_{k = 1}^{K} {x}_{N , k} {x}_{N , k} )\end{matrix} ] [ \begin{matrix}{w}_{1} \\ {w}_{2} \\ ⋮ \\ {w}_{N}\end{matrix} ] = [ \begin{matrix}( {\sum }_{k = 1}^{K} {x}_{1 , k} {y}_{k} ) \\ ( {\sum }_{k = 1}^{K} {x}_{2 , k} {y}_{k} ) \\ ⋮ \\ ( {\sum }_{k = 1}^{K} {x}_{N , k} {y}_{k} )\end{matrix} ] \qquad ( 9 )$$

The normal equation of Expression (9) can be solved with respect to the prediction coefficient wₙ by using discharge calculation (the Gauss-Jordan elimination method), for example. Also in the case of Expression (1), the prediction coefficient wᵢ and the prediction coefficient wⱼ can be obtained in a similar manner. Further, if the normal equation of Expression (9) is set up and solved for each of the classes, the optimal prediction coefficient (here, the prediction coefficient that minimizes the total sum E of the squared errors) wᵢ and the prediction coefficient wⱼ can be obtained for each of the classes.

Detailed Configuration Example of Coefficient Learning Portion 104

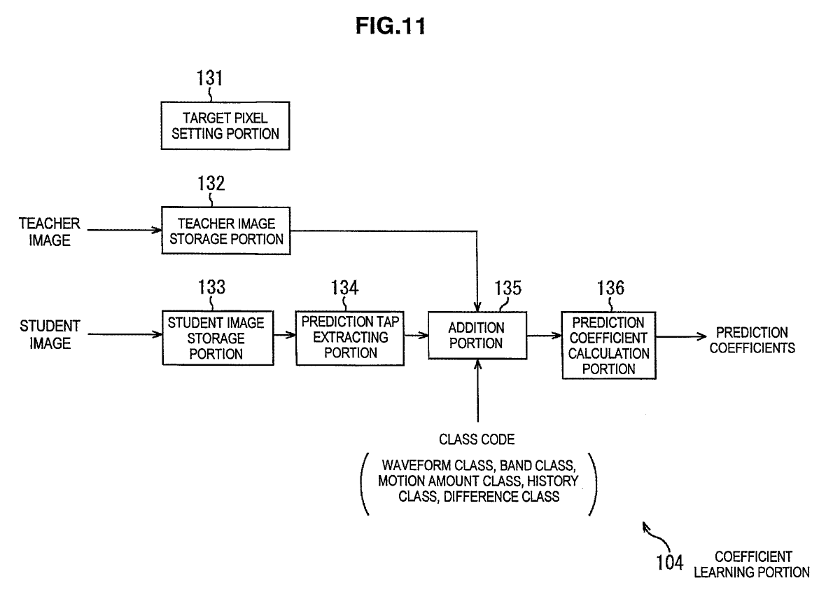

FIG. 11 is a block diagram showing a detailed configuration example of the coefficient learning portion 104 shown in FIG. 8.

The coefficient learning portion 104 is provided with a target pixel setting portion 131, a teacher image storage portion 132, a student image storage portion 133, a prediction tap extracting portion 134, an addition portion 135 and a prediction coefficient calculation portion 136.

The target pixel setting portion 131 sequentially sets each of the pixels that form the teacher image as the target pixel. Information indicating which position is set as the target pixel is supplied to each of the portions in the coefficient learning portion 104.

The teacher image storage portion 132 stores the ideal high resolution image as the input teacher image. The student image storage portion 133 stores the observed low resolution image as the input student image.

The prediction tap extracting portion 134 extracts surrounding pixels around the pixel corresponding to each target pixel, as the prediction tap, from among the pixels that form the student image stored in the student image storage portion 133, and supplies the extracted surrounding pixels to the addition portion 135.

The addition portion 135 reads the pixel value of the target pixel from the teacher image storage portion 132, and performs addition for the pixel value of the target pixel and the pixel values of the pixels of the student image that form the prediction tap formed with respect to the target pixel. The addition portion 135 performs the aforementioned addition for each class code identified by each of the supplied class codes. For example, a bit stream in which the respective class codes of the waveform class, the band class, the motion amount class, the history class and the difference class are arranged in a predetermined order is set as a final class code.

More specifically, for each class corresponding to the final class code determined based on each of the supplied class codes, the addition portion 135 performs multiplication (x_{n,k}x_{n′,k}) between the student images in a matrix of the left part of Expression (9) and an operation corresponding to summation (Σ), using the prediction tap (the student image) x_{n,k}.

Further, also for each class corresponding to the final class code, the addition portion 135 performs multiplication (x_{n,k}yₖ) between the student image x_{n,k} and the teacher image yₖ in a vector of the right part of Expression (9) and an operation corresponding to summation (Σ), using the prediction tap (the student image) x_{n,k} and the teacher image yₖ.

More specifically, the addition portion 135 stores a component (Σx_{n,k}x_{n′,k}) of the matrix of the left part and a component (Σx_{n,k}yₖ) of the vector of the right part of Expression (9) obtained a previous time with respect to teacher data set as the target pixel, in a memory (not shown in the drawings) incorporated in the addition portion 135. The addition portion 135 adds (performs addition represented by the summation in Expression (9)), to the component (Σx_{n,k}x_{n′,k}) of the matrix or the component (Σx_{n,k}yₖ) of the vector, corresponding components x_{n,k+1}x_{n′,k+1} or x_{n,k+1}yₖ₊₁ that are calculated using the teacher image yₖ₊₁ and the student image _{n,+1}.

Then, the addition portion 135 performs the above-described addition by setting all the teacher image pixels stored in the teacher image storage portion 132 as the target pixels, and thereby sets up, for each class, the normal equation represented by Expression (9). The addition portion 135 supplies the normal equation to the prediction coefficient calculation portion 136.

The prediction coefficient calculation portion 136 solves the normal equation for each class supplied from the addition portion 135, and thereby calculates, for each class, the prediction coefficient wₙ (the prediction coefficients wᵢ and wⱼ in Expression (1)) as an optimal parameter of Expression (2). The calculated prediction coefficients wᵢ and wⱼ for each class are stored in the learning database 82 (refer to FIG. 8).

Flowchart of Prediction Coefficient Learning Processing

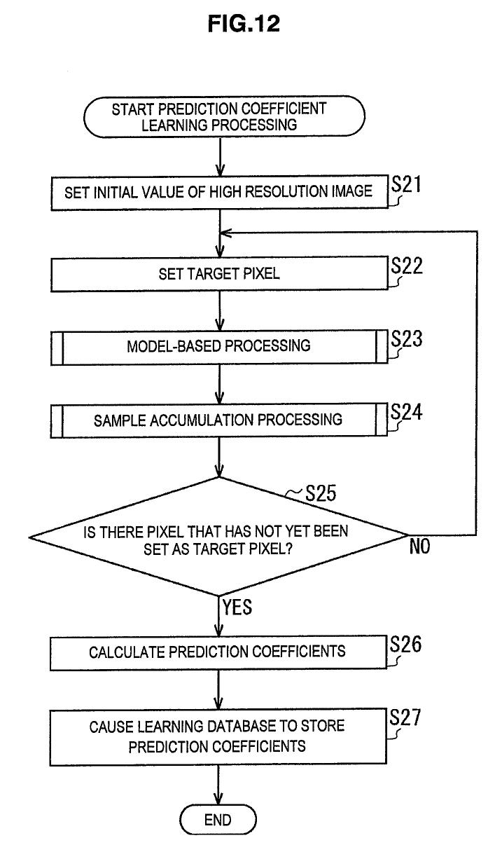

Next, prediction coefficient learning processing performed by the learning device 60 shown in FIG. 8 will be explained with reference to a flowchart shown in FIG. 12. Note that, it is assumed that the ideal high resolution image as the teacher image and the observed low resolution image as the student image are stored in the teacher image storage portion 132 and the student image storage portion 133, respectively, before this processing is started.

First, at step S21, the coefficient learning portion 104 sets an initial value of the high resolution image. As is apparent from Expression (1), the high resolution image of one frame before is necessary for the prediction operational expression. However, the high resolution image of one frame before is not present when starting the processing. Therefore, the high resolution image as the initial value is generated, for example, by up-converting the low resolution image that is the student image.

At step S22, the target pixel setting portion 131 sets, as a target pixel, a predetermined pixel of the high resolution image, which is the teacher image.

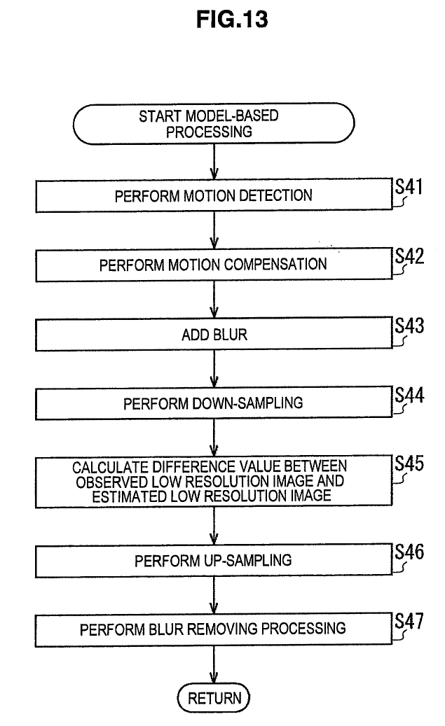

At step S23, the model-based processing portion 80 performs model-based processing, which will be described later with reference to FIG. 13.

The model-based processing that is performed as step S23 in FIG. 12 will be explained in detail with reference to a flowchart shown in FIG. 13.

At step S41, the motion detection portion 20 compares the high resolution image of one frame before that is supplied (fed back) from the coefficient learning portion 104 with a target frame, and detects a motion amount (a motion vector) of the target pixel. Then, the motion detection portion 20 supplies the detected motion amount to the temporal feature amount calculation portion 102 of the learning processing portion 81. Note that, in the first time processing in which the high resolution image of one frame before is not present, a value set in advance (NULL, for example) is output as the detection result.

At step S42, the motion compensation portion 21 performs motion compensation of the high resolution image based on the motion amount detected by the motion detection portion 20.

At step S43, the blur adding portion 22 adds blur, such as that occurs when an image is captured by a camera, to the motion-compensated high resolution image of one frame before. Here, generating an image in which the PSF, optical blur and the like of the camera are estimated (simulated) based on a predetermined image is referred to as blur adding.

At step S44, the down-sampler 23 generates a low resolution image by, for example, thinning out (performing down-sampling of) pixels of the motion-compensated high resolution image of one frame before to which blur is added. Thus, an estimated low resolution image is generated.

At step S45, the adder 24 calculates a difference value between corresponding pixels of the estimated low resolution image and the observed low resolution image that is the student image. Difference information, which is a calculation result of the adder 24, is supplied to the up-sampler 25.

At step S46, the up-sampler 25 performs up-sampling of the low resolution difference information, which is the calculation result of the adder 24, to difference information of the high resolution image. More specifically, the up-sampler 25 generates a difference value corresponding to an interpolated high resolution pixel based on the difference value corresponding to each of the pixels of the low resolution images, and supplies the generated difference value to the blur removing portion 26.

At step S47, the blur removing portion 26 performs the blur removing processing, which is the inverse processing of the processing performed by the blur adding portion 22, on the high resolution difference information supplied from the up-sampler 25. More specifically, the blur removing portion 26 performs, on the high resolution difference information, processing to remove the blur added by the blur adding portion 22.

This completes the model-based processing. The processing returns to FIG. 12 and proceeds to step S24.

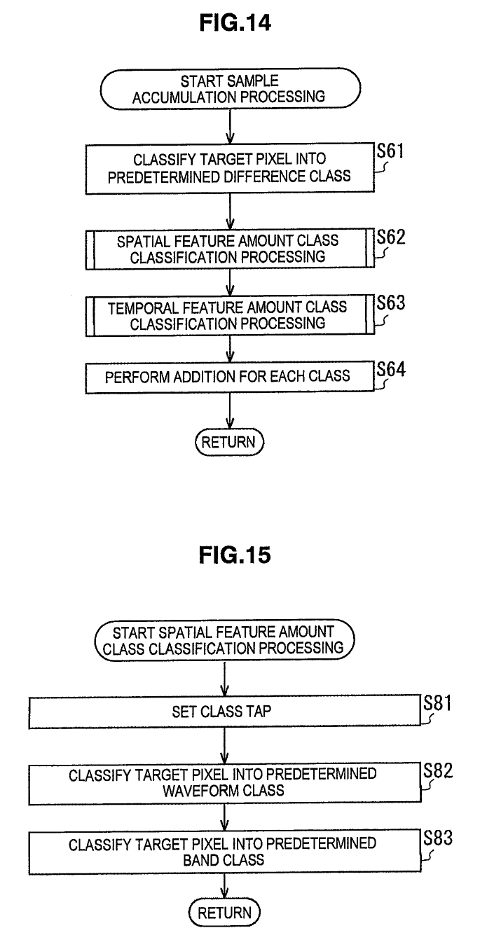

At step S24, the learning processing portion 81 performs sample accumulation processing, which will be described later with reference to FIG. 14.

The sample accumulation processing that is performed at step S24 in FIG. 12 will be explained in detail with reference to a flowchart shown in FIG. 14.

First, at step S61, the difference information class classification portion 103 classifies the target pixel into the predetermined difference class based on the difference information (the difference value) supplied from the blur removing portion 26. A class code indicating the difference class, which is a classification result, is supplied to the coefficient learning portion 104.

At step S62, the spatial feature amount calculation portion 101 sets a predetermined class tap with respect to the target pixel, and performs spatial feature amount class classification processing that performs class classification based on the spatial feature amount using the surrounding pixels extracted as the class tap.

At step S63, the temporal feature amount calculation portion 102 performs temporal feature amount class classification processing that performs class classification based on the temporal feature amount of the target pixel.

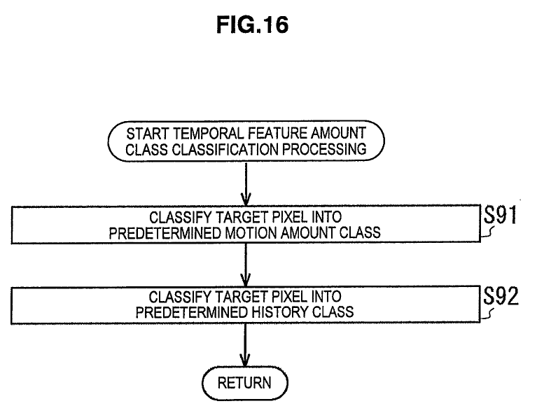

Here, the spatial feature amount class classification processing at step S62 and the temporal feature amount class classification processing at step S63 will be explained with reference to FIG. 15 and FIG. 16.

FIG. 15 shows a detailed flowchart of the spatial feature amount class classification processing at step S62.

At step S81, the class tap extraction portion 111 sets, with respect to the target pixel, a class tap to set a class based on the spatial feature amount, and extracts the class tap.

At step S82, the waveform pattern classification portion 112 classifies the target pixel into a predetermined waveform class based on a waveform pattern of the surrounding pixels extracted as the class tap, and outputs a class code indicating the waveform class to the coefficient learning portion 104 as a classification result.

At step S83, the band classification portion 113 classifies the target pixel into a predetermined band class based on a frequency band of the surrounding pixels of the target pixel, and outputs a class code indicating the band class to the coefficient learning portion 104 as a classification result.

This completes the spatial feature amount class classification processing at step S62 in FIG. 14.

FIG. 16 shows a detailed flowchart of the temporal feature amount class classification processing at step S63.

First, at step S91, the motion amount classification portion 121 classifies the target pixel into a predetermined motion amount class based on the motion amount supplied from the motion detection portion 20, and outputs a class code indicating the motion amount to the coefficient learning portion 104 as a classification result.

At step S92, the history counter classification portion 122 classifies the target pixel into a predetermined history class based on the number of processing times supplied from the coefficient learning portion 104, and outputs a class code indicating the history class to the coefficient learning portion 104 as a classification result.

This completes the temporal feature amount class classification processing at step S63 in FIG. 14.

Returning to FIG. 14, at step S64, the addition portion 135 performs addition corresponding to Expression (9) that represents the summation of the pixel value of the target pixel and the pixel values of the pixels of the student image that form the prediction tap extracted with respect to the target pixel. The addition portion 135 performs the addition corresponding to Expression (9) for each class code (each class) identified by each of the class codes of step S61 to step S63.

This completes the sample accumulation processing shown in FIG. 14. The processing returns to FIG. 12 and the processing proceeds from step S24 to step S25.

At step S25 in FIG. 12, the target pixel setting portion 131 of the coefficient learning portion 104 determines whether or not there is a pixel that has not yet been set as the target pixel.

When it is determined at step S25 that there is a pixel that has not yet been set as the target pixel, the processing returns to step S22 and the processing from step S22 onwards is repeatedly performed.

On the other hand, when it is determined at step S25 that all the pixels have been set as the target pixels, the processing proceeds to step S26.

At step S26, the prediction coefficient calculation portion 136 of the coefficient learning portion 104 solves the normal equation corresponding to Expression (9) for each class supplied from the addition portion 135, and thereby calculates the prediction coefficients wᵢ and wⱼ for each class.

At step S27, the prediction coefficient calculation portion 136 causes the learning database 82 to store, for each class, the prediction coefficients wᵢ and wⱼ calculated by the processing at step S26.

This completes the prediction coefficient learning processing.

Detailed Configuration Block Diagram of Prediction Device 40

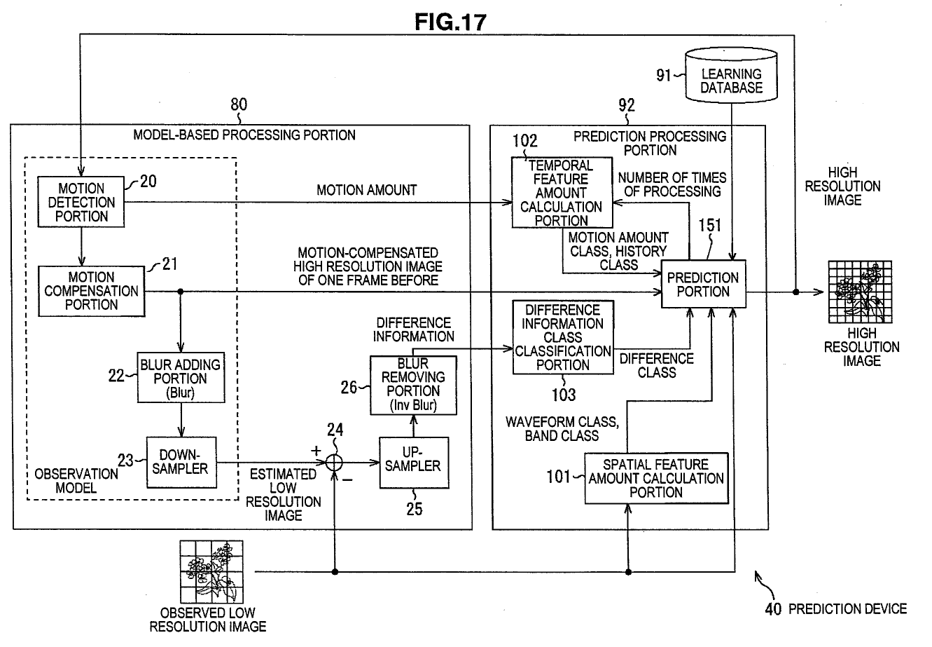

FIG. 17 is a block diagram showing a detailed configuration example of the prediction device 40. In FIG. 17, portions corresponding to the above-described portions are denoted by the same reference numerals and an explanation thereof is omitted as appropriate.

The prediction device 40 is provided with the model-based processing portion 80, the learning database 91 and the prediction processing portion 92.

The prediction coefficients wᵢ and wⱼ for each class that are learned by the learning device 60 and stored in the learning database 82 are copied and stored in the learning database 91.

The prediction processing portion 92 is provided with the spatial feature amount calculation portion 101, the temporal feature amount calculation portion 102, the difference information class classification portion 103 and a prediction portion 151.

The observed low resolution image input from the outside is supplied to the prediction processing portion 92. Further, in a similar manner to the learning device 60, the motion amount detected by the motion detection portion 20, the motion-compensated high resolution image of one frame before and the difference information are supplied from the model-based processing portion 80 to the prediction processing portion 92.

The prediction portion 151 sets, as the target pixel, each of the pixels in the high resolution image to be generated and extracts, as the prediction tap, a plurality of pixels of the observed low resolution image corresponding to each target pixel. Then, the prediction portion 151 performs the prediction operation of Expression (1), which is a product-sum operation of the prediction tap and the prediction coefficients. By doing this, the prediction portion 151 outputs the high resolution image that is predicted and generated by the prediction operation.

Detailed Configuration Example of Prediction Portion 151

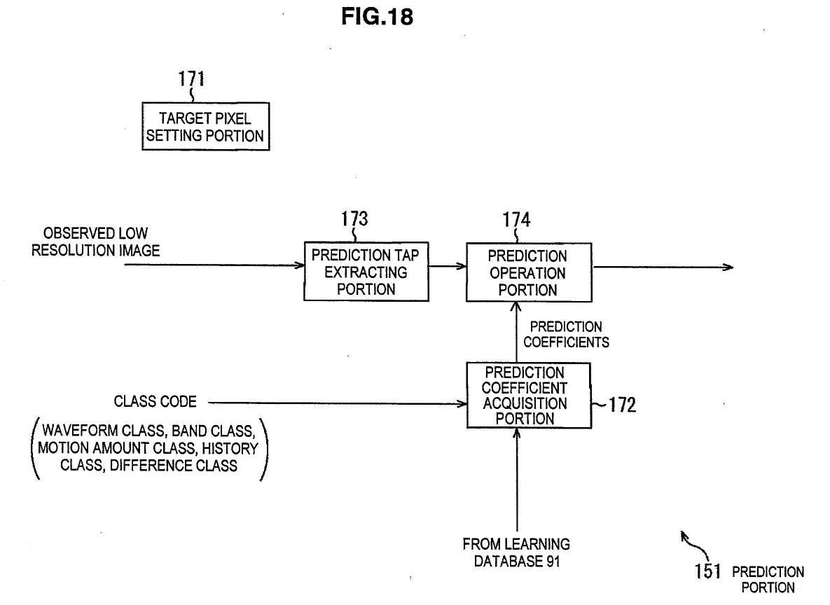

FIG. 18 is a block diagram showing a detailed configuration example of the prediction portion 151.

The prediction portion 151 is provided with a target pixel setting portion 171, a prediction coefficient acquisition portion 172, a prediction tap extracting portion 173 and a prediction operation portion 174.

The target pixel setting portion 171 sequentially sets, as a target pixel, each of the pixels that form the high resolution image to be generated. Information indicating which position is set as the target pixel is supplied to each of the portions in the prediction processing portion 92.

Class codes that are results obtained by classifying each target pixel into predetermined classes are supplied to the prediction coefficient acquisition portion 171 respectively from the spatial feature amount calculation portion 101, the temporal feature amount calculation portion 102 and the difference information class classification portion 103.

The prediction coefficient acquisition portion 172 determines, as a final class code, a bit stream in which the respective class codes of the waveform class, the band class, the motion amount class, the history class and the difference class are arranged in a predetermined order. Then, the prediction coefficient acquisition portion 172 acquires the prediction coefficients wᵢ and wⱼ corresponding to the final class code of the target pixel from the learning database 91, and supplies the prediction coefficients wᵢ and wⱼ to the prediction operation portion 174.

The prediction tap extracting portion 173 extracts, as a prediction tap, surrounding pixels around the pixel corresponding to the target pixel, from among the pixels that form the supplied observed low resolution image, and supplies the prediction tap to the prediction operation portion 174.

The prediction operation portion 174 predicts and generates a pixel value of the target pixel by performing the prediction operation that is the same as that used for learning, namely, the prediction operation represented by Expression (1).

Flowchart of High Resolution Image Generation Processing

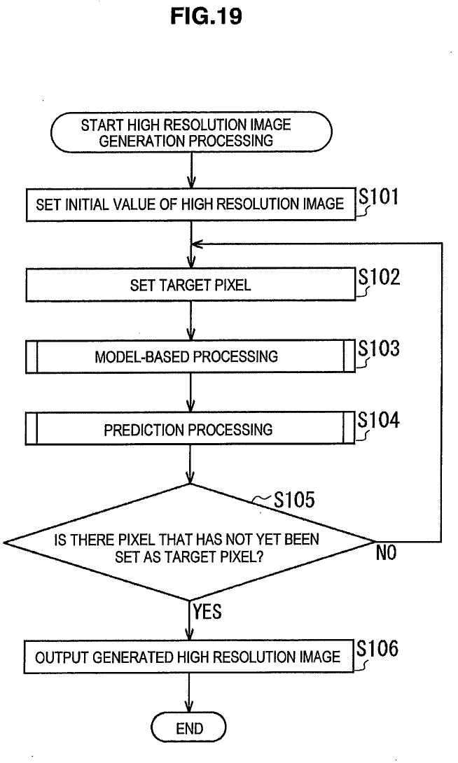

Next, high resolution image generation processing performed by the prediction device 40 shown in FIG. 17 will be explained with reference to a flowchart shown in FIG. 19. Note that it is assumed that the prediction coefficients wᵢ and wⱼ for each class that are learned by the learning device 60 are stored in the learning database 91 before this processing is started. This processing is started, for example, when the observed low resolution image is input.

Processing at step S101 to step S103 is the same as the processing at step S21 to step S23 in FIG. 12 performed by the learning device 60.

In summary, at step S101, the prediction portion 151 sets an initial value of the high resolution image.

At step S102, the target pixel setting portion 171 sets, as a target pixel, a predetermined pixel of the high resolution image that is to be generated.

At step S103, the model-based processing portion 80 performs the model-based processing explained with reference to FIG. 13.

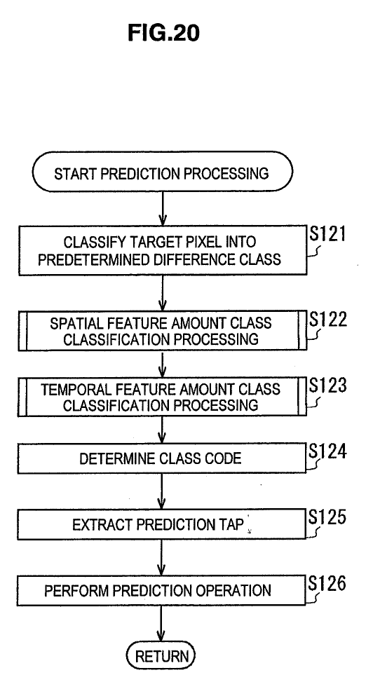

Then, at step S104, the prediction portion 151 performs prediction processing, which will be described later with reference to FIG. 20.

The prediction processing that is performed at step S104 in FIG. 19 will be explained in detail with reference to a flowchart shown in FIG. 20.

Processing from step S121 to step S123 is the same as the above-described processing at step S61 to step S63 in FIG. 14, and thus an explanation thereof is omitted here.

At step S124, the prediction coefficient acquisition portion 172 determines a final class code based on the class codes that are respectively supplied from the spatial feature amount calculation portion 101, the temporal feature amount calculation portion 102 and the difference information class classification portion 103. Then, the prediction coefficient acquisition portion 172 acquires, from the learning database 91, the prediction coefficients wᵢ and wⱼ corresponding to the final class code of the target pixel, and supplies the prediction coefficients wᵢ and wⱼ to the prediction operation portion 174.

At step S125, the prediction tap extracting portion 173 extracts, as the prediction tap, a plurality of pixels of the observed low resolution image corresponding to each target pixel.

At step S126, the prediction operation portion 174 performs the prediction operation represented by Expression (1), using the prediction tap extracted by the prediction tap extracting portion 173 and the prediction coefficients wᵢ and wⱼ acquired from the learning database 91 corresponding to the final class code of the target pixel. By doing this, the pixel value of the target pixel is obtained.

This completes the prediction processing. Returning to FIG. 19, the processing proceeds from step S104 to step S105.

At step S105 in FIG. 19, the prediction portion 151 determines whether or not there is a pixel that has not yet been set as the target pixel.

When it is determined at step S105 that there is a pixel that has not yet been set as the target pixel, the processing returns to step S102 and the processing from step S102 onwards is repeatedly performed.

On the other hand, when it is determined at step S105 that all the pixels have been set as the target pixels, the processing proceeds to step S106. The prediction operation portion 174 of the prediction portion 151 outputs the generated high resolution image and ends the processing. The high resolution image output from the prediction device 40 is input to a display device such as an LCD display, for example, and is displayed.

This completes the high resolution image generation processing.

In the above-described high resolution image generation processing performed by the prediction device 40, the spatial feature amount and the temporal feature amount are calculated with respect to the target pixel, and class classification of the target pixel is performed based on these feature amounts. Then, the prediction operation is performed using the prediction coefficients learned in advance that correspond to the classified class. Thus, the high resolution image is generated.

It is possible to perform an optimal correction based on the feature amount of each pixel, unlike the known model-based processing portion 10 that uniformly performs correction on the difference information to be generated. It is therefore possible to generate an optimal high resolution image. Specifically, it is possible to generate a high resolution image with improved anti-aliasing performance and improved resolution and sensitivity. Further, even if an estimation error occurs in a camera model or position alignment, it is possible to inhibit excessive emphasis of edges and details and isolated point-like degradation, for example. This is because, even if an estimation error occurs in a camera model or position alignment, the learning device 60 has learned the prediction coefficients that are used to generate an image close to the ideal image from the state including the estimation error.

Further, pixel values are calculated using the optimal prediction coefficients obtained in advance. Therefore, without performing a repeated operation a predetermined number of times as in the known model-based processing, it is possible to generate an optimal high resolution image by performing correction once for each frame. Accordingly, the high resolution image can be obtained in a short time and it is possible to easily realize high-speed processing.

Therefore, with the prediction device 40 and the learning device 60 to which the present technology is applied, an optimal up-converted image can be generated at a higher speed.

In the above-described embodiment, as the feature amount used to perform class classification of the target pixel, the waveform pattern and the frequency band are used as the special feature amount and the motion amount and the number of processing times are used as the temporal feature amount, in addition to the difference information between the observed low resolution image and the estimated low resolution image.

However, it is not necessary to use all of the spatial feature amount and the temporal feature amount. Only one of the above-described feature amounts may be used, or a predetermined two or three of them may be combined and used. In summary, it is sufficient if at least one of the above-described spatial feature amount and temporal feature amount is used. Further, a feature amount other than the spatial feature amount and the temporal feature amount may be used.

Further, algorithms other than class classification adaptation processing that performs class classification of the target pixel and adaptively performs processing depending on a classification result may be used as prediction and learning algorithms. For example, a neutral network, a support vector machine (SVM) and the like may be used.

The series of processes described above can be executed by hardware but can also be executed by software. When the series of processes is executed by software, a program that constructs such software is installed into a computer. Here, the expression “computer” includes a computer in which dedicated hardware is incorporated and a general-purpose personal computer or the like that is capable of executing various functions when various programs are installed.

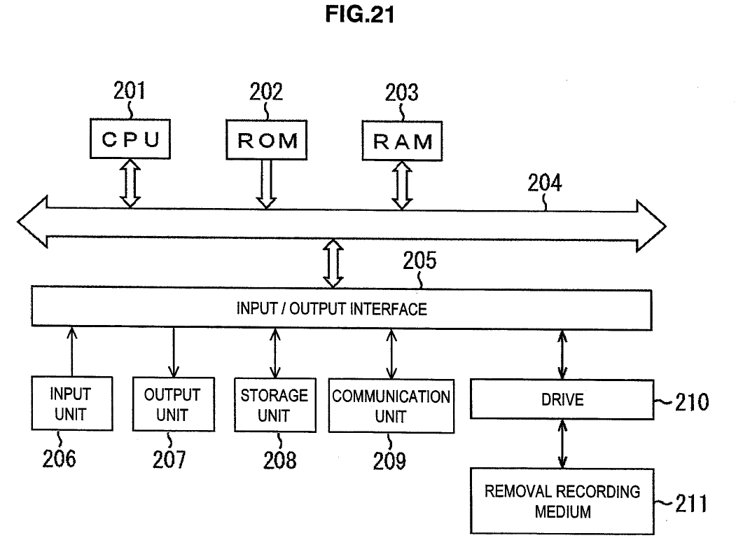

FIG. 21 is a block diagram showing an example configuration of the hardware of a computer that executes the series of processes described earlier according to a program.

In the computer, a central processing unit (CPU) 201, a read only memory (ROM) 202 and a random access memory (RAM) 203 are mutually connected by a bus 204.

An input/output interface 205 is also connected to the bus 204. An input unit 206, an output unit 207, a storage unit 208, a communication unit 209, and a drive 210 are connected to the input/output interface 205.

The input unit 206 is configured from a keyboard, a mouse, a microphone or the like. The output unit 207 configured from a display, a speaker or the like. The storage unit 208 is configured from a hard disk, a non-volatile memory or the like. The communication unit 209 is configured from a network interface or the like. The drive 210 drives a removable recording media 211 such as a magnetic disk, an optical disk, a magneto-optical disk, a semiconductor memory or the like.

In the computer configured as described above, the CPU 201 loads a program that is stored, for example, in the storage unit 208 onto the RAM 203 via the input/output interface 205 and the bus 204, and executes the program. Thus, the above-described series of processing is performed.

In the computer, by loading the removable recording medium 211 into the drive 210, the program can be installed into the storage unit 208 via the input/output interface 205. It is also possible to receive the program from a wired or wireless transfer medium such as a local area network, the Internet, digital satellite broadcasting, etc., using the communication unit 209 and install the program into the storage unit 208. As another alternative, the program can be installed in advance into the ROM 202 or the storage unit 208.

Note that steps written in the flowcharts accompanying this specification may of course be executed in a time series in the illustrated order, but such steps do not have to be executed in a time series and may be carried out in parallel or at necessary timing, such as when the processes are called.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1)

An image processing device including:

a model-based processing portion that generates an estimated low resolution image from a high resolution image, using an observation model that performs motion compensation processing and down-sampling processing;

a feature amount calculation portion that calculates a feature amount of at least one of a spatial feature amount and a temporal feature amount from one of an observed low resolution image, which is a low resolution image that is actually observed, and the high resolution image; and

a prediction operation portion that predicts and generates an image with higher image quality based on the high resolution image, using a parameter which corresponds to the calculated feature amount and which is obtained from the observed low resolution image, from the estimated low resolution image and from learning that is performed in advance.

(2)

The image processing device according to (1), wherein

the prediction operation portion predicts and generates the image with higher image quality based on the high resolution image, using the parameter corresponding to a class obtained when a pixel of the image to be generated is classified into a predetermined class, based on difference information between the observed low resolution image and the estimated low resolution image and on the calculated feature amount.

(3)

The image processing device according to (2), wherein

the prediction operation portion predicts and generates the image with higher image quality based on the high resolution image, by performing a product-sum operation between a prediction coefficient as the parameter corresponding to the class obtained when performing the class classification and pixel values of a plurality of pixels that are acquired from the observed low resolution image and the high resolution image corresponding to the pixel of the image to be generated.

(4)

The image processing device according to (2) or (3), wherein

the prediction operation portion sets, as a class code of the class obtained when performing the class classification of the pixel of the image to be generated, a class code obtained by combining a class code acquired from the difference information and a class code acquired from the calculated feature amount, and predicts and generates the image with higher image quality based on the high resolution image, using the parameter corresponding to the set class code.

(5)

The image processing device according to any of (1) to (4), wherein

the feature amount calculation portion calculates, as the feature amount, the spatial feature amount from the observed low resolution image.

(6)

The image processing device according to (5), wherein

the spatial feature amount is a waveform pattern of the observed low resolution image.

(7)

The image processing device according to (5) or (6), wherein

the spatial feature amount is a frequency band of the observed low resolution image.

(8)

The image processing device according to any of (1) to (7), wherein

the feature amount calculation portion calculates, as the feature amount, the temporal feature amount from the high resolution image.

(9)

The image processing device according to (8), wherein

the temporal feature amount is a motion amount of the high resolution image that is detected by the motion compensation processing.

(10)

The image processing device according to (8) or (9), wherein

the temporal feature amount is a number of times that processing that predicts and generates the image with higher image quality based on the high resolution image is performed.

(11)

The image processing device according to any of (1) to (10), wherein

the observation model also performs blur adding processing that adds blur.

(12)

An image processing method including:

generating an estimated low resolution image from a high resolution image, using an observation model that performs motion compensation processing and down-sampling processing;

calculating a feature amount of at least one of a spatial feature amount and a temporal feature amount from one of an observed low resolution image, which is a low resolution image that is actually observed, and the high resolution image; and

predicting and generating an image with higher image quality based on the high resolution image, using a parameter which corresponds to the calculated feature amount and which is obtained from the observed low resolution image, from the estimated low resolution image and from learning that is performed in advance.

(13)

A program including instructions that command a computer to perform:

generating an estimated low resolution image from a high resolution image, using an observation model that performs motion compensation processing and down-sampling processing;

calculating a feature amount of at least one of a spatial feature amount and a temporal feature amount from one of an observed low resolution image, which is a low resolution image that is actually observed, and the high resolution image; and

predicting and generating an image with higher image quality based on the high resolution image, using a parameter which corresponds to the calculated feature amount and which is obtained from the observed low resolution image, from the estimated low resolution image and from learning that is performed in advance.

(14)

A recording medium on which the program according to (13) is recorded.

The present disclosure contains subject matter related to that disclosed in Japanese Priority Patent Application JP 2011-155711 filed in the Japan Patent Office on Jul. 14, 2011, the entire content of which is hereby incorporated by reference.

What is claimed is:

1. An image processing device comprising:
a model-based processing portion that generates an estimated low resolution image from a high resolution image, using an observation model that performs motion compensation processing and down-sampling processing;
a feature amount calculation portion that calculates a feature amount of at least one of a spatial feature amount and a temporal feature amount from one of an observed low resolution image, which is a low resolution image that is actually observed, and the high resolution image; and
a prediction operation portion that predicts and generates an image with higher image quality based on the high resolution image, using a parameter which corresponds to the calculated feature amount and which is obtained from the observed low resolution image, from the estimated low resolution image and from learning that is performed in advance.

2. The image processing device according to claim 1, wherein
the prediction operation portion predicts and generates the image with higher image quality based on the high resolution image, using the parameter corresponding to a class obtained when a pixel of the image to be generated is classified into a predetermined class, based on difference information between the observed low resolution image and the estimated low resolution image and on the calculated feature amount.

3. The image processing device according to claim 2, wherein
the prediction operation portion predicts and generates the image with higher image quality based on the high resolution image, by performing a product-sum operation between a prediction coefficient as the parameter corresponding to the class obtained when performing the class classification and pixel values of a plurality of pixels that are acquired from the observed low resolution image and the high resolution image corresponding to the pixel of the image to be generated.

4. The image processing device according to claim 2, wherein
the prediction operation portion sets, as a class code of the class obtained when performing the class classification of the pixel of the image to be generated, a class code obtained by combining a class code acquired from the difference information and a class code acquired from the calculated feature amount, and predicts and generates the image with higher image quality based on the high resolution image, using the parameter corresponding to the set class code.

5. The image processing device according to claim 1, wherein
the feature amount calculation portion calculates, as the feature amount, the spatial feature amount from the observed low resolution image.

6. The image processing device according to claim 5, wherein
the spatial feature amount is a waveform pattern of the observed low resolution image.

7. The image processing device according to claim 5, wherein
the spatial feature amount is a frequency band of the observed low resolution image.

8. The image processing device according to claim 1, wherein
the feature amount calculation portion calculates, as the feature amount, the temporal feature amount from the high resolution image.

9. The image processing device according to claim 8, wherein
the temporal feature amount is a motion amount of the high resolution image that is detected by the motion compensation processing.

10. The image processing device according to claim 8, wherein
the temporal feature amount is a number of times that processing that predicts and generates the image with higher image quality based on the high resolution image is performed.

11. The image processing device according to claim 1, wherein
the observation model also performs blur adding processing that adds blur.

12. An image processing method comprising:
generating an estimated low resolution image from a high resolution image, using an observation model that performs motion compensation processing and down-sampling processing;
calculating a feature amount of at least one of a spatial feature amount and a temporal feature amount from one of an observed low resolution image, which is a low resolution image that is actually observed, and the high resolution image; and
predicting and generating an image with higher image quality based on the high resolution image, using a parameter which corresponds to the calculated feature amount and which is obtained from the observed low resolution image, from the estimated low resolution image and from learning that is performed in advance.

13. A program comprising instructions that command a computer to perform:
generating an estimated low resolution image from a high resolution image, using an observation model that performs motion compensation processing and down-sampling processing;
calculating a feature amount of at least one of a spatial feature amount and a temporal feature amount from one of an observed low resolution image, which is a low resolution image that is actually observed, and the high resolution image; and
predicting and generating an image with higher image quality based on the high resolution image, using a parameter which corresponds to the calculated feature amount and which is obtained from the observed low resolution image, from the estimated low resolution image and from learning that is performed in advance.

14. A recording medium on which the program according to claim 13 is recorded.
